(19) United States
(12) Patent Application Publication
(10) Pub. No.: US 2014/0344624 A1
(43) Pub. Date: Nov. 20, 2014

(54) OPERATION DATA ANALYSIS APPARATUS, METHOD AND NON-TRANSITORY COMPUTER READABLE MEDIUM

(71) Applicant: KABUSHIKI KAISHA TOSHIBA, Minato-ku (JP)

(72) Inventors: Takeichiro NISHIKAWA, Yokohama-Shi (JP); Minoru NAKATSUGAWA, Yokohama-Shi (JP); Tooru MAMATA, Akiruno-Shi (JP); Yoshihiro KANEKO, Fussa-Shi (JP)

(73) Assignee: KABUSHIKI KAISHA TOSHIBA, Minato-ku (JP)

(21) Appl. No.: 14/278,498

(22) Filed: May 15, 2014

(30) Foreign Application Priority Data
May 17, 2013 (JP) 2013-105477

(51) Int. Cl. G06F 11/07

(52) U.S. Cl. CPC G06F 11/0778
USPC 714/37

(57) ABSTRACT

There is provided an analysis apparatus including: a first storage to store operation data on an electronic device; a second storage to store a span characteristic concerning a time span in which each of values of a plurality of explanatory variables is changed; an explanatory variable calculator to calculate the explanatory variables based on the operation data; a failure state information calculator to calculate failure state information for the electronic device based on the explanatory variables calculated by the explanatory variable calculator, and calculate, when the failure state information represents a risky state, an overall span concerning in what time span the failure state information is possibly to represent a safe state due to changes in the values of the explanatory variables; and a diagnosis unit to diagnose the electronic device based on the failure state information and the overall span characteristic.

### CROSS-REFERENCE TO RELATED APPLICATIONS

This application is based upon and claims the benefit of priority from Japanese Patent Application No. 2013-105477, filed May 17, 2013; the entire contents of which are incorporated herein by reference.

### FIELD

Embodiments described herein relate to an operation data analysis apparatus, a method and a non-transitory computer readable medium storing a program for evaluation of a possibility of a failure in an electronic device on the basis of data on the operation of the electronic device.

### BACKGROUND

Grasping the soundness of a storage is important in ensuring the preservation of data stored in the storage. A method of monitoring the soundness of a storage on the basis of immediately preceding internal information output from the storage exists. A method of inferring a future soundness of a device by assuming that internal information values change monotonously in future also exists.

Many hard disk drive (HDD) diagnosis tools based on Self-Monitoring, Analysis and Reporting Technology (S.M.A.R.T.) exist and many such tools are being publicly released free. Ordinarily, such a tool diagnoses a hard disk drive as having a failure when terms in S.M.A.R.T. exceed threshold values. S.M.A.R.T. is a function incorporated in a hard disk drive for the purpose of early detection of faults and prediction of a failure in the hard disk drive. By this function, self-diagnosis is performed with respect to each of diagnosis items and the results of diagnosis are expressed by numeric values.

A method is also known in which a straight light passing through a use state point and a current SMART value is prepared and a point in time at which the straight line exceeds a threshold value is estimated as a point in time at which a failure has occurred.

In a hard disk drive, temporal occurrence of a read error and a reduction in response speed for example is caused by vibration or an impact received or mixing in of particles. After success is attained in solving the problem by taking relief measures in the storage, the piece of hardware operates with no problem.

The conventional methods, however, are incapable of evaluating a failure risk in a storage by considering such a temporal change in state in the storage.

In a case where a failure risk is timely evaluated in response to short-span time-sequential changes in internal information, the failure risk is frequently changed and a user is unnecessarily worried thereby.

### BRIEF DESCRIPTION OF THE DRAWINGS

FIG. 1 is a block diagram of a storage operation data analysis apparatus according to a first embodiment;

FIG. 2 is a flowchart of the overall operation according to the first embodiment;

FIG. 3 is a flowchart of processing for calculating an overall span characteristic according to the first embodiment;

FIG. 4 is a flowchart of processing for determination as to execution/non-execution of filtering according to the first embodiment;

FIG. 5 is a flowchart showing filtering 1 and the flow of rank calculation processing according to the first embodiment;

FIG. 6 is a flowchart showing filtering 2 and the flow of rank calculation processing according to the first embodiment;

FIG. 7 is a block diagram of a storage operation data analysis apparatus according to a second embodiment;

FIG. 8 is a flowchart of processing for updating of a failure probability calculation formula according to the second embodiment;

FIG. 9 is a block diagram of a storage operation data analysis apparatus according to a third embodiment; and

FIG. 10 is a flowchart of the operation of a filter parameter modification unit according to the third embodiment.

### DETAILED DESCRIPTION

There is provided an operation data analysis apparatus including: a first storage, a second storage, an explanatory variable calculator, a failure state information calculator and a diagnosis unit.

The first storage stores operation data on an electronic device.

The second storage stores a span characteristic concerning a time span in which each of values of a plurality of explanatory variables is changed.

The explanatory variable calculator calculates the plurality of explanatory variables based on the operation data.

The failure state information calculator calculates failure state information for the electronic device based on the plurality of explanatory variables calculated by the explanatory variable calculator, and calculates, when the failure state information represents a risky state, an overall span characteristic concerning in what time span the failure state information is possibly to represent a safe state due to changes in the values of the explanatory variables.

The diagnosis unit diagnoses the electronic device based on the failure state information and the overall span characteristic.

Hereinafter, embodiments will be described with reference to the drawings.

### First Embodiment

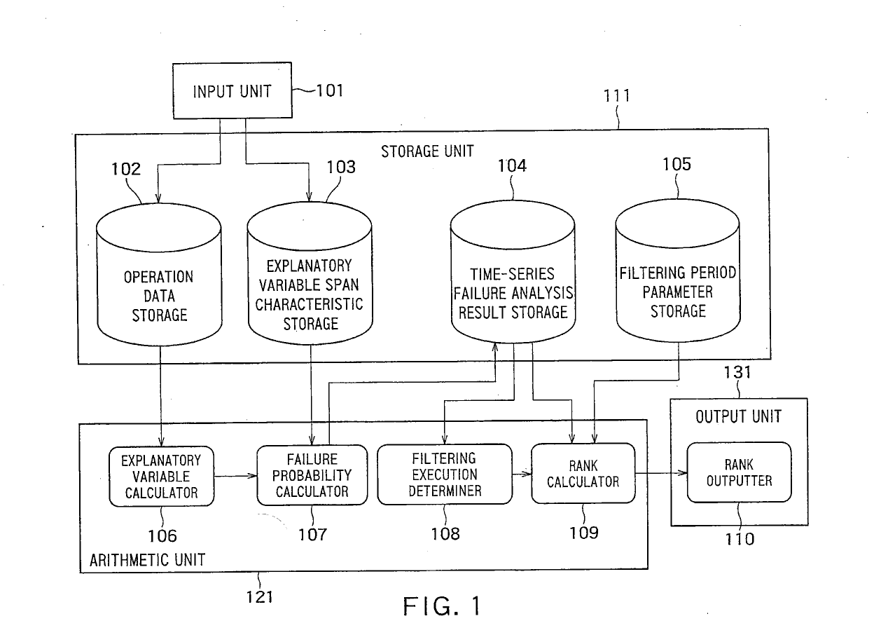

FIG. 1 is a block diagram of a storage operation data analysis apparatus according to a first embodiment.

This analysis apparatus is provided with an input unit 101, a storage unit 111, an arithmetic unit 121 and an output unit 131. The provision of all these units is not indispensable for this analysis apparatus. For example, the analysis apparatus can be constituted only by the storage unit 111 and the arithmetic unit 121.

The input unit 101 is a unit for inputting data to be supplied to an operation data storage 102 and an explanatory variable span characteristic storage 103 in the storage unit 111. The input unit 101 may be a piece of equipment such as a keyboard or a mouse, a piece of equipment that reads data from a recording medium such as a CD-ROM or a memory, or a piece of equipment that collects data from an external place through a network.

The operation data storage 102 stores operation data on an electronic device supplied from the input unit 101. Table 1 shows an example of data items constituting operation data. Items of operation data may be the same as items in S.M.A.R.T. (Self-Monitoring, Analysis and Reporting Technology).

TABLE 1

| Data item No. | Item name |
|---|---|
| 1 | Housing angle (PC angle) |
| 2 | CPU temperature |
| 3 | HDD temperature |
| 4 | Number of alternative sectors |
| 5 | Operating time |
| 6 | Number of powering on/off times |
| 7 | Seek error rate |
| 8 | Read error rate |
| 9 | HDD operating capacity |
| 10 | Vibration |

Table 2 shows an example of data stored in the operation data storage 102.

In this example, data on an electronic device is collected at a point in time when the electronic device is first operated in a day, and the collected data is stored in the operation data storage 102.

No data is collected unless the electronic device is turned on. Accordingly, no data exists with respect to January 3, 4, 7, 8, and 9 and it can be understood that the electronic device was not used on those days.

TABLE 2

| Data | | | | | | | |
|---|---|---|---|---|---|---|---|
| item | | Janu- | Janu- | Janu- | Janu- | Janu- | |
| No. | Item name | ary 1 | ary 2 | ary 5 | ary 6 | ary 10 | . . . |
| 1 | Housing angle | 0 | 0 | 0 | 0 | 0 | . . . |
| 2 | CPU temperature | 35 | 21 | 40 | 23 | 37 | . . . |
| 3 | HDD temperature | 25 | 26 | 25 | 28 | 26 | . . . |
| 4 | Number of | 100 | 100 | 100 | 99 | 99 | . . . |
| | alternative sectors | | | | | | |
| 5 | Operating time | 111 | 115 | 117 | 121 | 129 | . . . |
| | (cumulative) | | | | | | |
| 6 | Number of | 35 | 37 | 38 | 40 | 41 | . . . |
| | powering on/off | | | | | | |
| | times (cumulative) | | | | | | |
| 7 | Seek error rate | 100 | 100 | 100 | 100 | 100 | . . . |
| 8 | Read error rate | 100 | 100 | 100 | 99 | 99 | . . . |
| 9 | HDD operating | 222 | 222 | 223 | 225 | 225 | . . . |
| | capacity | | | | | | |
| 10 | Vibration | 0 | 0 | 0 | 0 | 0 | . . . |

An explanatory variable calculator 106 reads out an operation data history accumulated in the operation data storage 102 and calculates explanatory variables. The explanatory variables are used for calculation of failure state information about a device. With respect to the present embodiment, failure state information assumed to be a failure probability will be described by way of example. Information associated with a failure state may suffice as failure state information. For example, failure state information may be a value indicating one of a plurality of states corresponding to magnitudes of a risk of failure, or a result of evaluation of a span of time before failure. Table 3 shows an example of explanatory variables. For example, an explanatory variable 3 is a standard deviation of most recent fifteen takes of data on the read error rate stored in the operation data storage 102.

TABLE 3

| Explanatory | | | Period of |
|---|---|---|---|
| variable No. | Name of data item used | Processing | data used |
| 1 | Pending sector | Current value | One day |
| 2 | Number of powering | Average value | Eight days |
| | on/off times | | |
| 3 | Read error rate | Standard | Fifteen days |
| | | deviation | |
| 4 | Seek error rate | Standard | Fifty days |
| | | deviation | |
| 5 | HDD operating capacity | Standard | Thirty days |
| | | deviation | |

The explanatory variable span characteristic storage 103 stores explanatory variable span characteristic data supplied from the input unit 101. The explanatory variable span characteristic data includes a span characteristic set with respect to each explanatory variable and a definition of the span characteristic. The span characteristic represents an index (i.e., rough indication) of a span of time from an arbitrary point in time to a point in time at which the value of an explanatory variable is changed.

Table 4 shows an example of span characteristics set for explanatory variables 1 to 5. Table 5 shows an example of definitions of span characteristics. In definitions of span characteristics, variation below a certain limit may be not regarded as variation; only variation exceeding a certain limit may be regarded as variation.

TABLE 4

| Explanatory | Span |
|---|---|
| variable ID | characteristic |
| 1 | Short-span |
| 2 | Short-span |
| 3 | Medium-span |
| 4 | Long-span |
| 5 | Long-span |

TABLE 5

| Span | |
|---|---|
| characteristic | Definition |
| Short-span | There is a possibility of the value being |
| | changed when the number of days in which |
| | a device was activated is 10 or less |
| Medium-span | There is a possibility of the value being |
| | changed when the number of days in which |
| | the device was activated is 20 or less |
| Long-span | There is a possibility of the value being |
| | changed when the number of days in which |
| | the device was activated is 21 or more |

In the example shown in Table 5, span characteristics are expressed by being divided into three classes: short-span; medium-span; and long-span, with reference to the number of days in which the device was activated and at which a possibility of change of the explanatory variable (numeric value) arises. Even a day in which the device is activated two or more times is counted as one.

The expression of span characteristics is not limited to classification. Span characteristics can be expressed in terms of number of times or a period of time. For example, a span characteristic can be expressed by an operation time period before the value of an explanatory variable is changed.

A failure probability calculator (failure state information calculator) 107 calculates a probability of failure in a device on the basis of explanatory variables calculated by the explanatory variable calculator 106. Calculation of the failure probability is performed, for example, on a daily basis. Failure probability calculation may be not performed with respect to a day in which the device is not activated. The failure probability calculator 107 records the calculated failure probability in a time-series failure analysis result storage 104 in the storage unit 111 together with an ID for the device.

Logit transform, for example, can be used for calculation of a failure probability. Logit transform is made by taking a weighted sum of explanatory variables to calculate a failure probability. An example of calculation of a failure probability using Logit transform is shown by formula I:

$$p = \frac{1}{1 + exp [ - ( {a}_{0} + {a}_{1} {x}_{1} + {a}_{2} {x}_{2} + {a}_{3} {x}_{3} ) ]} \qquad Formula 1$$

In this example shown here, three explanatory variables x₁, x₂, and x₃ are used. Symbols “a₀, a₁, a₂ and a₃” represent parameters (coefficients) having values given in advance. The failure probability changes according to the values of the explanatory variables “x₁, x₂, and x₃”. A value of “p” is associated with the failure probability.

It is not necessarily required that the failure probability in the present invention coincide with the failure probability itself. The failure probability may be failure state information, which may be a value indicating one of a plurality of states according to the magnitude of a failure risk or a result of evaluation of a span of time before failure. The failure state information may alternatively be a numeric value associated with the failure probability, e.g., a numeric value having a strong correlation with the failure probability.

The failure probability calculator 107 determines whether or not the current state is risky from the calculated failure probability. In the present embodiment, determination as to whether or not the current state is risky is made from whether or not the calculated failure probability is equal to or higher than a threshold value “α” set in advance. If the calculated failure probability is equal to or higher than a threshold value “α”, an overall span characteristic representing an index (i.e., rough indication) indicating in what time span the failure probability returns to a safe state is calculated assuming that the failure probability is returned to a value lower than the threshold value “α” with changes in explanatory variables. In the present embodiment, determination as to whether or not the current state is safe is made from whether or not the calculated failure probability is lower than the threshold value. That is, if the failure probability is lower than the threshold value, the current state is safe. The overall span characteristic can alternatively be said to represent an index (i.e., rough indication) indicating in what time span there is a possibility of return to normal values of some explanatory variables having abnormal values and largely influential on the failure probability in the explanatory variables used for calculation of the failure probability. If the calculated failure probability is lower than the threshold value “α” (if failure state information indicates a safe state), the overall span characteristic may be not calculated.

A filtering execution determiner 108 and a rank calculator 109 constitutes a diagnosing unit that diagnoses an electronic device on the basis of a calculated failure probability and an overall span characteristic.

The filtering execution determiner 108 determines whether or not filtering is to be executed on the basis of an overall span characteristic relating to a failure probability and a calculated failure probability. “Filtering” means processing for calculating information for determining ranks by using a history of failure probabilities, i.e., a failure probability presently calculated and failure probabilities within a filtering period calculated in the past. The filtering period is stored as a filtering period parameter within a filtering period parameter storage 105. If filtering is not executed, the rank calculator 109 described below directly determines a failure rank (diagnosis rank) from the failure probability. In the case of executing filtering, information is calculated from a failure probability history, and a failure rank is determined from the information.

That is, the filtering execution determiner 108 determines which one of a first diagnosis method and a second diagnosis method is to be carried out. The first diagnosis method calculates a failure rank from a failure probability presently calculated (when filtering is not performed) and the second diagnosis method calculates a failure rank by using a failure probability history (when filtering is performed). If the failure probability calculated by the failure probability calculator 107 is lower than the threshold value “α”, determination to perform the first diagnosis method is made. If the failure probability calculated by the failure probability calculator 107 is equal to or higher than the threshold value α, determination is made to perform the first diagnosis method or the second diagnosis method according to an overall span characteristic and the failure probability. For example, if the overall span characteristic is “short-span”, and if the failure probability is lower than a threshold value “β” (>α), determination is made to perform the second diagnosis method. In other cases, determination is made to perform the first diagnosis method. Methods other than the first and second diagnosis methods may be defined.

When determination is made to perform the first diagnosis method (in a case where filtering is not performed), the rank calculator 109 determines a failure rank from the failure probability. For example, one of three ranks is determined on the basis of the threshold value “α” and the threshold value “β” higher than the threshold value “α”. “Green” (normal) is determined if the failure probability is lower than the threshold value “α”. “Yellow” (warning) is determined if the failure probability is equal to or higher than “α” and lower than “β”. “Red” is determined if the failure probability is equal to or higher than “β”. Green, yellow and red correspond to a normal level, a warning level and an abnormal level, respectively. Ranking such as this is only an example. Any method may be used if it enables classification into a plurality ranks. The number of ranks is not limited to three. While calculation of a rank is performed as a method of diagnosing a device in this embodiment, the diagnosis method is not limited to calculation of a rank. A different index can be used if it is a value indicating a state of a device.

When determination is made to perform the second diagnosis method (in a case where filtering is performed), the rank calculator 109 obtains information on the filtering period from the filtering period parameter storage 105 and determines a failure rank by using data on failure probabilities within the filtering period. Details of this operation are described later.

A rank outputter 110 in the output unit 131 outputs the rank determined by the rank calculator 109. Information on the overall span characteristic calculated by the failure probability calculator 107 may also be output. Any form of output may be selected. For example, an output may be displayed on a display or transmitted to an external place.

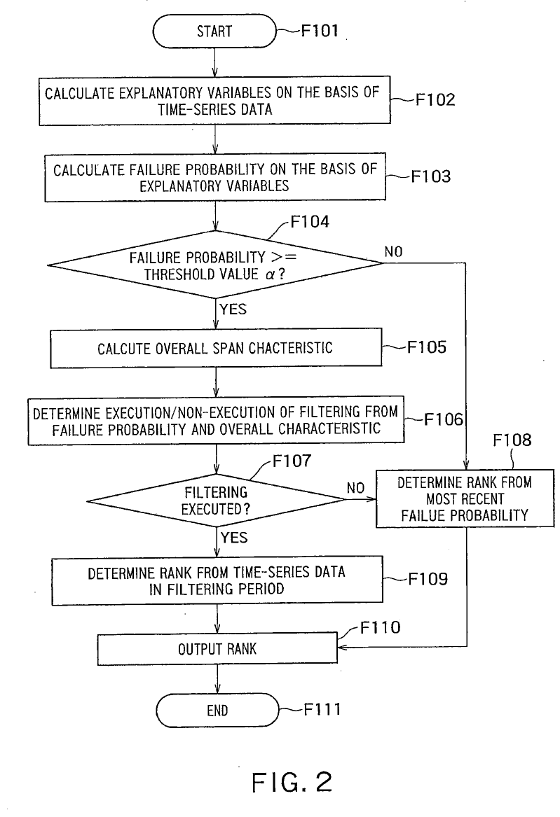

FIG. 2 is a flowchart of the overall operation according to the present embodiment.

The operation is started in step F101 and the explanatory variable calculator 106 calculates a plurality of explanatory variables on the basis of time-series operation data (F102).

The failure probability calculator 107 calculates a failure probability of an electronic device on the basis of the calculated explanatory variables (F103). Determination is made as to whether or not the calculated failure probability is equal to or higher than the threshold value “α” (F104). When the calculated failure probability is lower than the threshold value “α”, the rank calculator 109 determines a rank on the basis of the failure probability calculated in step F103 (F108). The rank outputter 110 then outputs the rank (F110) and the operation in this flow ends (F111).

When the calculated failure probability is equal to or higher than the threshold value “α”, the failure probability calculator 107 calculates an overall span characteristic relating to the failure probability (F105). The filtering execution determiner 108 determines execution or non-execution of filtering (which one of the first and second diagnosis methods is to be used) from the calculated failure probability and overall span characteristic (F106).

If non-execution of filtering is determined (determination is made to use the first diagnosis method), a failure rank is determined on the basis of the failure probability calculated in step F103 (F108). The rank outputter 110 then outputs the determined failure rank (F110) and the operation in this flow ends (F111).

On the other hand, if execution of filtering is determined (determination is made to use the second diagnosis method), a failure rank is determined on the basis of data on the failure probabilities within the filtering period (F109). The rank outputter 110 then outputs the determined failure rank (F110) and the operation in this flow ends (F111).

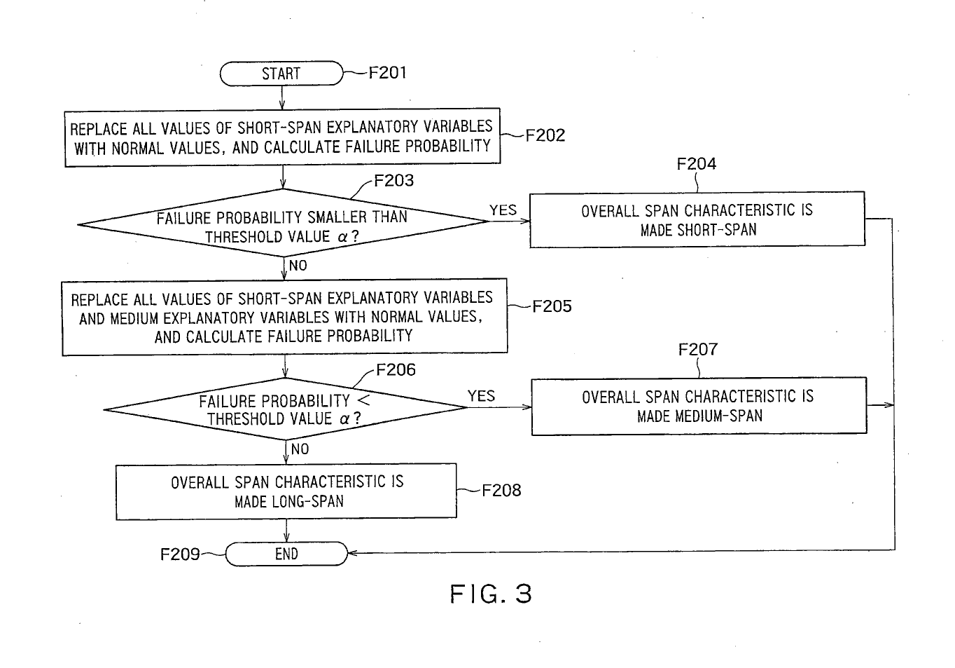

FIG. 3 shows a flowchart of processing for calculating an overall span characteristic, which is performed in step F105.

Execution of the process is started in step F201 and all the short-span explanatory variables are replaced with normal values and a failure probability is calculated (F202). The normal values are given in advance. Only the explanatory variables deviating from the normal ranges in the short-span explanatory variables may be replaced with the normal values given in advance; the explanatory variables within the normal ranges may be not replaced.

The failure probability calculated in step F202 is compared with the threshold value “α”. If the failure probability is lower than the threshold value “α”, the overall span characteristic is made “short-span” (F204). That is, it is assumed that there is a possibility of the failure probability returning to a value lower than “α” in a short time span (within ten days) (there is a possibility of the short-span explanatory variables returning to normal values in a short time span).

If the failure probability calculated in step F202 is equal to or higher than the threshold value “α”, all the values of the short-span explanatory variables and medium-span variables are replaced with normal values and a failure probability is calculated (F205). That is, the value of one explanatory variable and the values of explanatory variables of shorter-span span characteristics relative to the one explanatory variable are replaced with normal values. Only the explanatory variables whose values are out of the normal ranges may be replaced with normal values.

If the failure probability calculated in step F205 is lower than the threshold value “α” (F206), the overall span characteristic is made “medium-span” (F207). That is, it is assumed that there is a possibility of the failure probability returning to a value lower than “α” in a medium time span (within twenty days) (there is a possibility of the short-span and medium-span explanatory variables returning to normal values in a medium time span).

If the failure probability calculated in step F205 is equal to or higher than the threshold value “α”, the overall span characteristic is made “medium-span” in F208.

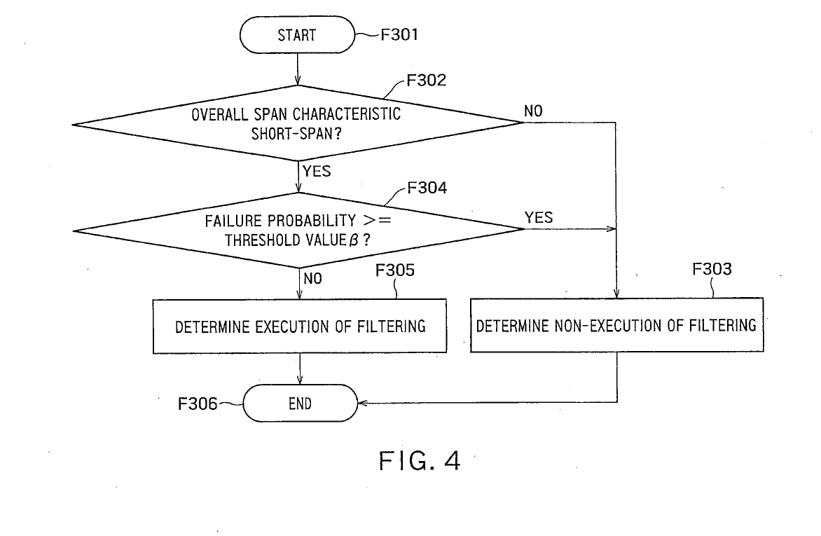

FIG. 4 shows a flowchart of processing for determination as to execution/non-execution of filtering, which is performed in step F106.

Processing is started in step F301 and the filtering execution determiner 108 checks whether or not the overall span characteristic is short-span (F302). If the overall span characteristic is not short-span, that is, if the overall span characteristic is medium-span or long-span, determination is made not to perform filtering (determination is made to calculate a rank by the first diagnosis method) (F303).

If the overall span characteristic is short-span, a check is made as to whether the failure probability calculated in step F103 in FIG. 2 is equal to or higher than the predetermined threshold value “β” (>α) (F304).

If the failure probability is lower than “β”, determination is made to execute filtering (to calculate a rank by the second diagnosis method) (F305) and processing in this flow ends (F306). The possibility of unnecessarily warning the user in a situation where the failure probability is changed in a short time span (for example, a situation where the failure probability is reduced below the threshold value “α” after several days) can be reduced by performing filtering.

On the other hand, if the failure probability is equal to or higher than “β”, determination is made not to perform filtering (determination is made to calculate a rank by the first diagnosis method) (F303) and processing in this flow ends (F306). This is because the failure probability equal to or higher than “β” is such a level that a warning should be immediately given even if there is a possibility of the failure probability being reduced after several days.

In step F302 in the flowchart shown in FIG. 4, the process proceeds to step F304 if the overall span characteristic is short-span. However, the process may proceeds to step F305 if the overall span characteristic is short-span or medium-span.

The rank calculator 109 receives the filtering execution determination result (as to which one of the first and second diagnosis methods is to be performed) from the filtering execution determiner 108, as described above, and obtains failure probabilities from the time-series failure analysis result storage 104. The rank calculator 109 checks the filtering execution/non-execution and determines a rank of failure in the device on the basis of the most recent failure probability (the failure probability calculated in step F202) in the case of non-execution of filtering (first diagnosis method).

In the case of execution of filtering (second diagnosis method), the rank calculator 109 obtains information on the filtering period from the filtering period parameter storage 105 and obtains information for determining a failure rank from the history of failure probabilities within the filtering period. The rank calculator 109 determines a rank of failure in the device on the basis of this information. Two concrete examples of filtering and rank calculation processing will be described below.

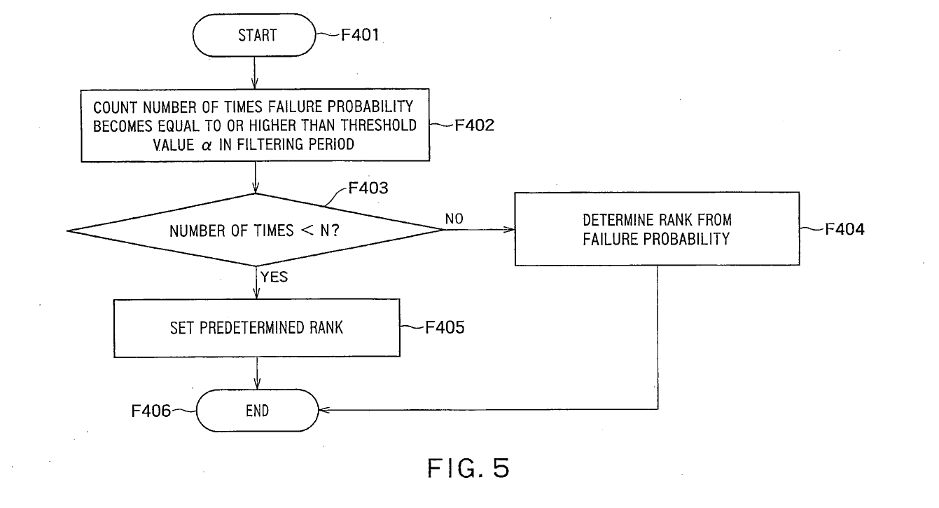

FIG. 5 is a flowchart showing filtering 1 and the flow of rank calculation when filtering 1 is performed.

Processing is started in step F401 and the number of times the failure probability became equal to or higher than the threshold value “α” on the days in a predetermined length of time (filtering period) before the present day is counted in step F402. The filtering period may be all the days for which past data exists (all the days after the start of measurement). The counted number corresponds to information for determining a failure rank.

If the number counted in step F402 is equal to or higher than a number “N” designated in advance, a failure rank is determined from the failure probability (F404) and this processing ends (F406).

On the other hand, if the number counted in step F402 is lower than the number “N”, a predetermined rank is determined (F405) and this processing ends. The predetermined rank is assumed here to be a safe rank “green” at which no warning is given.

Ordinarily, if the failure probability varies in a short span, it is supposed that the risk after a warning is given a number of times larger than “N” is higher than the risk when the warning is first given. Accordingly, giving an unnecessary warning may be avoided by giving no warning on first N−1 chances to give a warning, even if the failure probability is equal to or higher than “α”.

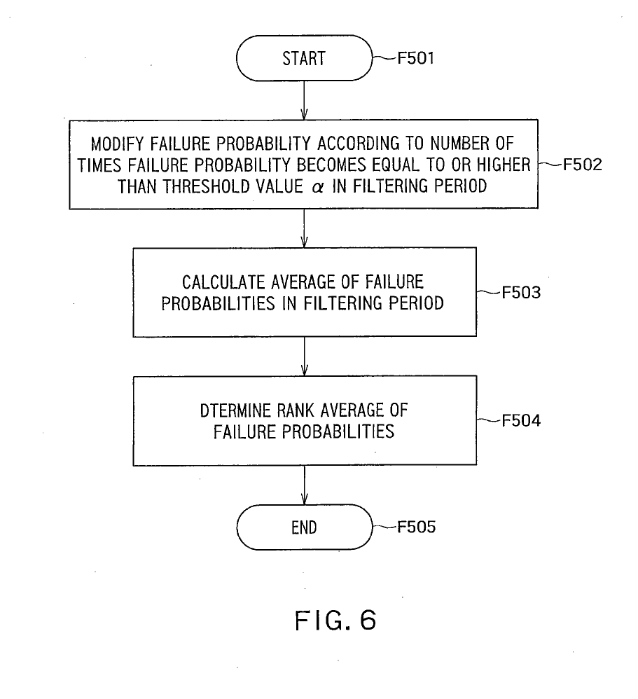

FIG. 6 is a flowchart showing filtering 2 and the flow of rank calculation when filtering 2 is performed.

Processing is started in step F501 and the failure probability is modified in step F502 according to the number of times the failure probability became equal to or higher than “α” after the start of measurement with respect to each of the days when the failure probability became equal to or higher than the threshold value “α” within the filtering period.

More specifically, the failure probabilities equal to or higher than the threshold value “α” are multiplied by multiplying factors with respect to the cumulative numbers of times according to a conversion table such as Table 6. The values of the failure probabilities are converted thereby. In the present embodiment, cumulative numbers of times are calculated from the measurement start point. A mode of implementation is also possible in which cumulative numbers of times are calculated from the beginning of the filtering period.

TABLE 6

| Number | Multiplying |
|---|---|
| of times | factor |
| 1 | 0.7 |
| 2 | 0.7 |
| 3 | 0.7 |
| 4 | 0.7 |
| 5 | 0.7 |
| 6 | 1.5 |
| 7 | 1.5 |
| 8 | 1.5 |
| 9 | 1.5 |
| 10 | 1.5 |
| 11 or | 1.8 |
| more | |

For example, it is assumed that α=1.8%. In a case where the current failure probability is 2% and the failure probability became equal to or higher than “α” for the first time, 2% is multiplied by 0.7 and the current failure probability is thereby converted into 1.4%. In a case where the current failure probability has the same value 2% and the failure probability became equal to or higher than “α” seven times, the failure probability is converted into 2%×1.5=3%.

Table 7 shows an example of the history of failure probabilities, multiplying factors applied to the failure probabilities equal to or higher than the threshold value “α” and converted failure probabilities obtained by multiplying the failure probabilities by the multiplying factors.

TABLE 7

| | | | Converted | |
|---|---|---|---|---|
| | Failure | Multiplying | failure | |
| Date | probability | factor | probability | |
| January 1 | 0.1% | — | 0.10% | |
| January 2 | 2.0% | 0.7 | 1.40% | |
| January 5 | 2.0% | 0.7 | 1.40% | |
| January 6 | 2.0% | 0.7 | 1.40% | |
| January 10 | 0.1% | — | 0.10% | |
| January 11 | 0.1% | — | 0.10% | |
| January 12 | 2.5% | 0.7 | 1.75% | |
| January 13 | 0.1% | — | 0.10% | |
| January 15 | 2.5% | 0.7 | 1.75% | |
| January 16 | 0.1% | — | 0.10% | |
| January 18 | 0.1% | — | 0.10% | |
| January 19 | 2.5% | 1.5 | 3.75% | |
| January 20 | 2.5% | 1.5 | 3.75% | |
| | | | 1.29% | Average |

If the filtering period is the most recent ten days, data for the most recent ten days (filtering period) is data from January 6 to January 20. It is assumed that α=1.8%. Multiplying factors are calculated in accordance with Table 6 with respect to the failure probabilities equal to or higher than the threshold value “α”. The failure probabilities are multiplied by the multiplying factor to obtain converted failure probabilities.

The converted failure probabilities within the filtering period are averaged to obtain an average converted failure probability of 1.29% (F503). This average converted failure probability corresponds to information for determining a failure rank.

A rank is determined from the average converted failure probability (F504). For example, a green rank is determined if the average converted failure probability is lower than the threshold value “α”. A yellow rank is determined if the average converted failure probability is equal to or higher than the threshold value “α” and lower than the threshold value “β”. A red rank is determined if the average converted failure probability is equal to or higher than the threshold value “β”.

In this method, the average converted failure probability is reduced and tends to be lower than “α” if the frequency with which the failure probability becomes equal to or higher than the threshold value “α” is low. In this case, giving an unnecessary warning can be avoided by giving no warning.

In the above-described method, weighting is performed according to cumulative numbers of times each of which is the number of times the failure probability became equal to or higher than the threshold value. A different method is also possible in which the failure probabilities within the filtering period are simply averaged without performing weighting.

In the present embodiment, an overall span characteristic relating to the failure probability is calculated when the failure probability is equal to or higher than the threshold value “α”, and a failure rank is determined by using a history of failure probabilities if the overall span characteristic is short-span, (or short-span or medium-span) and if the failure probability is lower than the threshold value “β”. A failure rank can thus be calculated by considering temporary changes in state of the device. As a result, the possibility of giving an unnecessary warning to the user can be reduced.

### Second Embodiment

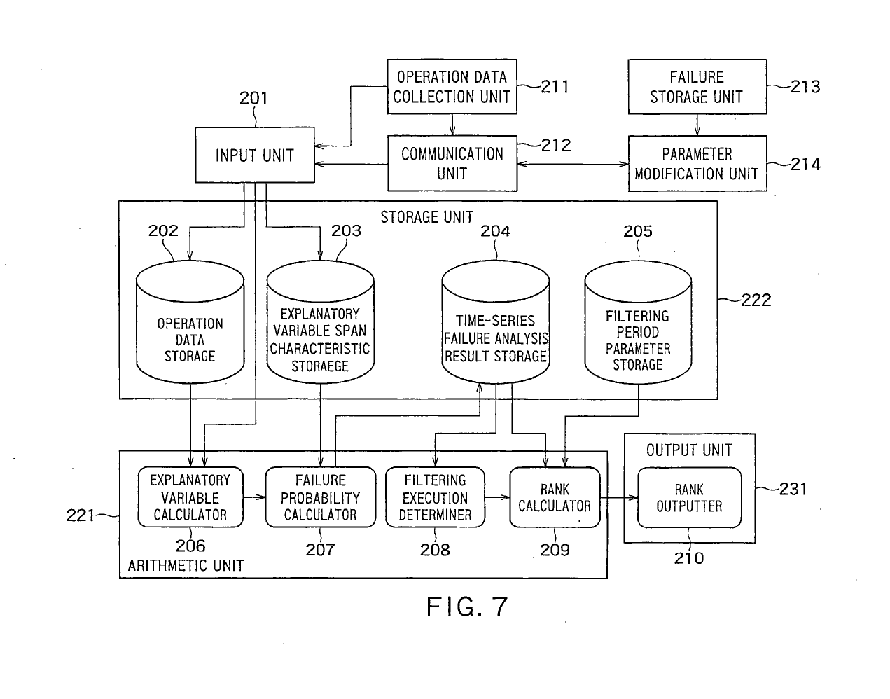

FIG. 7 is a block diagram of a storage operation data analysis apparatus according to a second embodiment. Blocks having the same names as those shown in FIG. 1 perform basically the same operations as those in the first embodiment. These blocks are renumbered and descriptions other than descriptions of expanded or changed processes are omitted to avoid redundancies.

An operation data collection unit 211 collects operation data on a plurality of electronic devices through a network not illustrated and supplies the collected operation data to an input unit 201. The operation data collection unit 211 also supplies the collected operation data to a communication unit 212. The communication unit 212 transmits the operation data received from the operation data collection unit 211 to a parameter modification unit 214.

A failure storage unit 213 stores identification information such as serial numbers for electronic devices having failures, and failure data such as dates of failure. As a date of failure, a date of recognition of a failure in a repair center, a date of recognition of a failure by a user, or the like can be used. If data on the dates of failure can be read out from the devices, the dates in this data may alternatively be used. It is assumed that no data exists in the failure storage unit 213 with respect to the devices in which no failures have occurred.

Dates of repairs on the devices may be included in the failure data. The devices after the completion of repairs may be treated as devices having no failures.

The parameter modification unit 214 receives operation data from the communication unit 212, receives electronic device failure data from the failure storage unit 213, and modifies (updates) a failure probability calculation formula. The parameter modification unit 214 sends the modified calculation formula via the communication unit 212 and the input unit 201 to a failure probability calculator 207 or a storage that can be accessed from the failure probability calculator 207.

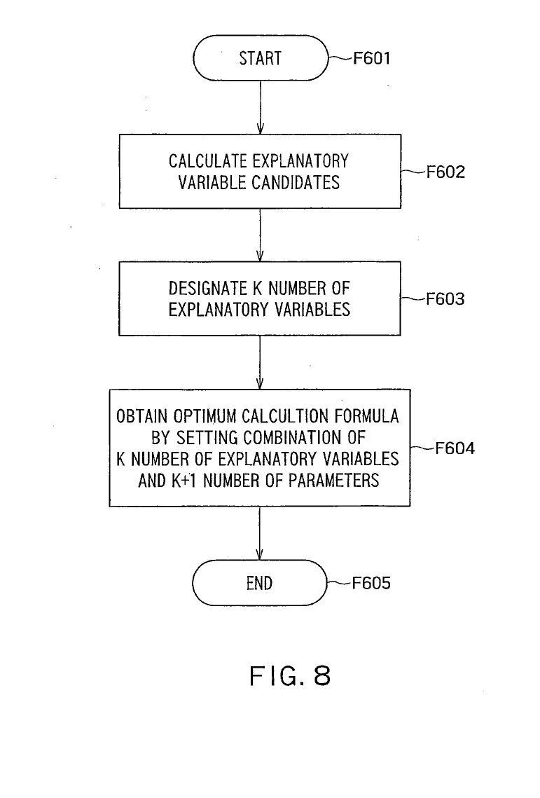

FIG. 8 shows a flow of updating of the failure probability calculation formula.

It is assumed that the current failure probability calculation formula is using only three explanatory variables “x₁, x₂, and x₃” in five explanatory variables (candidate explanatory variables).

Processing is started in step F601 and the five explanatory variables are calculated in step F602 on the basis of operation data sent from a plurality of devices. The explanatory variables for the device i are

written as “x₁⁽ⁱ⁾, x₂⁽ⁱ⁾, x₃⁽ⁱ⁾, x₄⁽ⁱ⁾, and x₅⁽ⁱ⁾”.

Next, in step F603, a number K of the explanatory variables is determined. It is assumed here that K=3.

In step F604, a logarithmic likelihood:

$$l = {\sum }_{i}^{ } log ( {c}_{i} {p}_{i} + ( 1 - {c}_{i} ) ( 1 - {p}_{i} ) )$$

is calculated. In this formula,

$${p}_{i} = \frac{1}{1 + exp [ - ( {a}_{0} + {a}_{s} {x}_{s}^{( i )} + {a}_{t} {x}_{t}^{( i )} + {a}_{u} {x}_{u}^{( i )} ) ]}$$

If the device i is a failed device, “cᵢ” is 1. If the device i is a non-failed device, “cᵢ” is 0.

Determination as to whether the device i is a failed device or a non-failed device is made by checking whether or not the device i had a failure within a certain time period after the point in time at which collection of operation data was started. If the device i had a failure within the certain time period after the point in time at which collection of operation data was started, it is treated as a failed device. If the device i had no failure, it is treated as a non-failed device.

In step F604, K=3 number of explanatory variables “s, t, and u” are selected and parameters “a₀, aₛ, aₜ, and aᵤ” included in the calculation formula of “pᵢ” are determined so that the logarithmic likelihood of the failure probability is maximized. If “s, t, u, a₀, aₛ, aₜ, and aᵤ” are determined, the calculation formula is definite. The parameters are determined with respect to a plurality of or all combinations of three explanatory variables so that the logarithmic likelihood is maximized. The combination of explanatory variables when the maximum logarithmic likelihood is obtained is adopted.

In the present embodiment, as described above, the values of explanatory variables and parameters (coefficients) to be used can be determined so that the accuracy of the failure probability calculation formula is improved.

### Third Embodiment

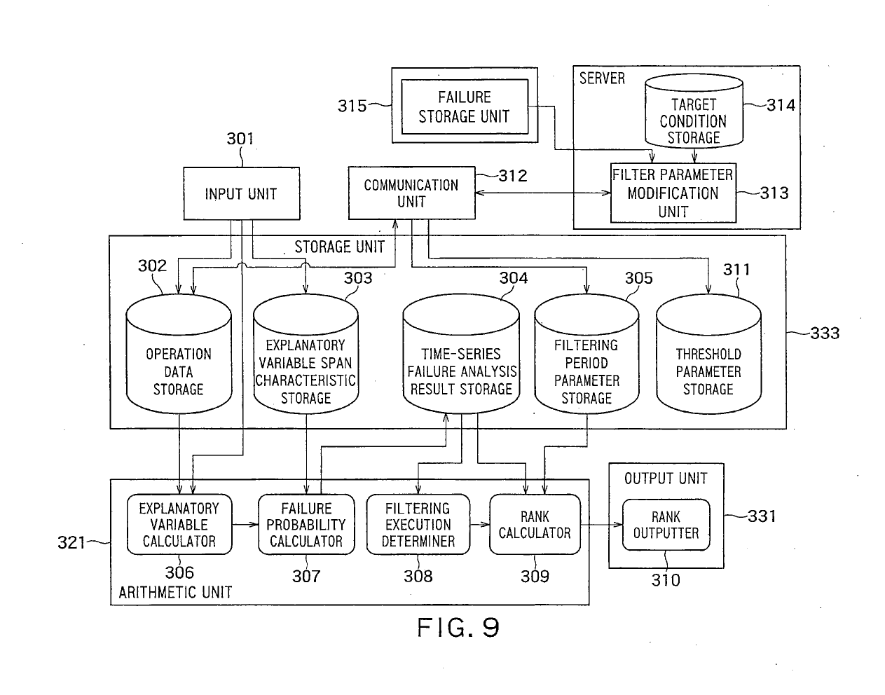

FIG. 9 is a block diagram of a storage operation data analysis apparatus according to a third embodiment. Blocks having the same names as those shown in FIG. 7 perform basically the same operations as those in the second embodiment. These blocks are renumbered and descriptions other than descriptions of expanded or changed processes are omitted to avoid redundancies.

In a threshold parameter storage 311, the value “N” for a filtering period and threshold values “α” and “β” are recorded.

A communication unit 312 obtains operation data stored in an operation data storage 302 and transmits the operation data to a filter parameter modification unit 313.

The filter parameter modification unit 313 receives operation data from multiple devices and modifies (updates) the filtering period “N” and the threshold value “β”. The filter parameter modification unit 313 sends the modified “N” and “β” to the threshold parameter storage 311 via the communication unit 312 and an input unit 301.

A target condition storage 314 stores target values of “z1” and “z2” as information used by the filter parameter modification unit 313 in determination of the values of “N” and “β”.

The value “z1” represents a proportion occupied by ranks “red” and “yellow” of failed devices in the devices from which operation data has been collected. The value “z2” represents a proportion occupied by ranks “red” and “yellow” in all the devices from which operation data has been collected. The proportion occupied by ranks “red” and “yellow” is the sum of the proportion occupied by rank “red” and the proportion occupied by rank “yellow” of ranks “red”, “yellow” and “green”. In place of the proportion occupied by ranks “red” and “yellow”, the proportion occupied by rank “red” or the proportion occupied by rank “yellow” may be used.

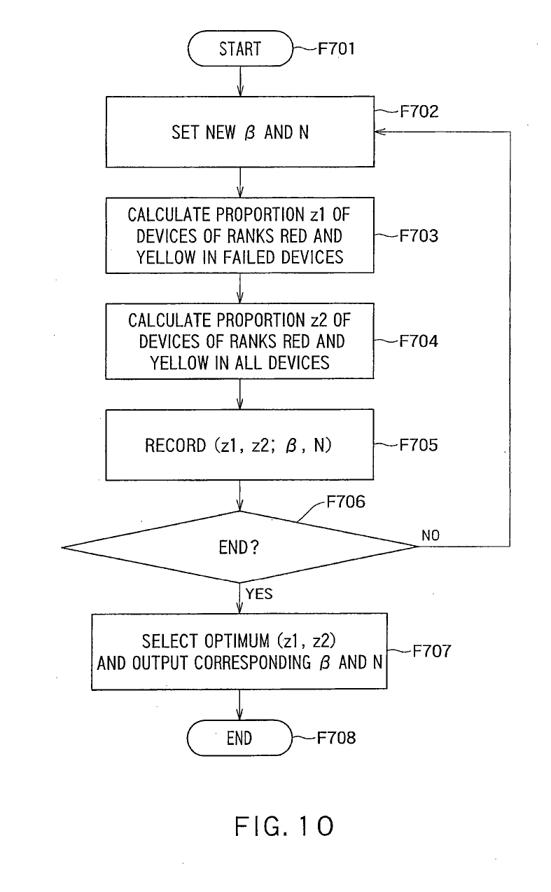

FIG. 10 shows a flowchart of the operation of the filter parameter modification unit 313 according to the present embodiment.

Processing is started in step F701 and the threshold value “β” and the filtering period “N” are set in step F702. As these values, values stored in a list in advance are successively set.

When the end of the list is reached, the end of processing is determined in step F706. Processing may alternatively be such that “β” and “N” are randomly generated and the end of processing is determined in step F706 after “β” and “N” have been generated a certain number of times.

In step F703, calculation of a failure probability and determination of a rank are performed on each of the devices from which data has been collected. These processing may be performed in the same way as in the first embodiment. A storage unit 333 and an arithmetic unit 321 may be used. Units similar to the storage unit 333 and the arithmetic unit 321 may be provided in the filter parameter modification unit 313. Devices (failed devices) that had failures within a certain time period after the point in time at which collection of operation data was started in the devices from which data has been collected are identified by means of a failure storage unit 315. The proportion of the devices having ranks “red” and “yellow” in the failed devices (more generally, a numeric value calculated from the proportion) is calculated. This value is obtained as “z1”. In place of the proportion occupied by ranks “red” and “yellow”, the proportion occupied by rank “red” or the proportion occupied by rank “yellow” may be used.

In step F704, the proportion of the devices having ranks “red” and “yellow” in all the devices from which data has been collected is calculated. This proportion is obtained as “z2”. In place of the proportion occupied by ranks “red” and “yellow”, the proportion occupied by rank “red” or the proportion occupied by rank “yellow” may be used, as in step F703. While two values “z1” and “z2” are calculated in this example, only one proportion may be calculated or three or more proportions may be calculated. In such a case, subsequent processing may be changed as desired according to the number of proportions calculated.

In step F705, “β” and “N” set in step S702 and “z1” and “z2” calculated in steps F703 and F704 are recorded. These values are expressed collectively as (z1, z2; β, N).

In step F706, determination is made as to whether or not the ending condition is satisfied. If the ending condition is not satisfied, the process returns to step F702. One of “β” and “N” or both “β” and “N” are changed and the same calculation is repeatedly performed, thereby recording (z1, z2; β, N) with respect to each combination of “β” and “N”.

If the ending condition is satisfied, the process proceeds to step F707 and an optimum (z1, z2) is selected.

A method of selecting the optimum (z1, z2) is such that a combination of “z1” and “z2” in which “z1” is higher while “z2” is lower is selected. More specifically, a point closest to the target values (z1*, z2*), which is stored in the target condition storage 314, in a set of points (Pareto-optimal set) in which any point (z1′, z2′) of a higher z1 and a lower z2 does not exist with respect to other combinations is selected. At this time, “p” and “N” corresponding to the selected (z1, z2) are output.

In the present embodiment, as described above, the threshold value “β” and the filtering period “N” can be determined as optimum values.

Each of the operation data analysis apparatuses in the embodiments can also be realized by using a general-purpose computer apparatus as basic hardware. That is, each processing unit in the operation data analysis apparatus can be realized by making a processor incorporated in the computer apparatus execute a program. At this time, the operation data analysis apparatus may be realized by installing the program in the computer apparatus in advance or by installing the program in the computer apparatus when necessary. To install the program when necessary, the program may be stored on a storage medium such as a CD-ROM or delivered through a network. Each storage in the operation data analysis apparatus can be realized by using as desired a recording medium or the like, e.g., a memory, a hard disk, a CD-R, a CD-RW, a DVD-RAM or a DVD-R incorporated in or externally attached to the computer apparatus.

The input unit shown in FIG. 1 may remotely receive operation data on a device via the Internet or an in-house LAN and store the operation data in the operation data storage 102. At this time, the storage unit and the arithmetic unit can be implemented on a server. Also, the output unit may output a result on an administrator's screen in the server and may transmit a result via the Internet or the in-house LAN.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. An operation data analysis apparatus comprising:
a first storage to store operation data on an electronic device;
a second storage to store a span characteristic concerning a time span in which each of values of a plurality of explanatory variables is changed;
an explanatory variable calculator to calculate the plurality of explanatory variables based on the operation data;
a failure state information calculator to calculate failure state information for the electronic device based on the plurality of explanatory variables calculated by the explanatory variable calculator, and calculate, when the failure state information represents a risky state, an overall span characteristic concerning in what time span the failure state information is possibly to represent a safe state due to changes in the values of the explanatory variables; and
a diagnosis unit to diagnose the electronic device based on the failure state information and the overall span characteristic.

2. The apparatus according to claim 1, further comprising a third storage to store a history of failure state information calculated by the failure state information calculator,
wherein the diagnosis unit determines a method of diagnosing the electronic device based on the failure state information and the overall span characteristic, diagnoses the electronic device from the failure state information calculated by the failure state information calculator when a first diagnosis method is determined, and diagnoses the electronic device based on the history of failure state information in the third storage when a second diagnosis method is determined.

3. The apparatus according to claim 2, wherein the diagnosis unit diagnoses the electronic device based on a number of times the failure state information represents a risky state in the history of the failure state information.

4. The apparatus according to claim 2, wherein the diagnosis unit diagnoses the electronic device based on an average of the failure state information in the history of the failure state information.

5. The apparatus according to claim 2, wherein the diagnosis unit weights the failure state information when the failure state information represent a risky state, according to the number of times that before the failure state information is calculated, failure state information representing a risky state in the history of the failure state information are calculated, and diagnoses the electronic device based on an average of weighted failure state information.

6. The apparatus according to claim 2, wherein the diagnosis unit diagnoses the electronic device by using data within a filtering period in the history of the failure state information.

7. The apparatus according to claim 1, wherein the failure state information is a failure probability wherein the failure information represents a risky state when the failure probability is equal to or higher than a threshold value, and represents a safe state when the failure probability is lower than the threshold value.

8. The apparatus according to claim 2, wherein the failure state information is a failure probability wherein the failure information represents a risky state when the failure probability is equal to or higher than a threshold value, and represents a safe state when the failure probability is lower than the threshold value, and
the diagnosis unit determines the first diagnosis method when the failure probability is lower than the threshold value, when the overall span characteristic is shorter than a first time span, or when the overall span characteristic is equal to or longer than the first time span and when the failure probability is equal to or higher than a first threshold value higher than the threshold value, and determines the second diagnosis method when the overall span characteristic is equal to or longer than the first time span and when the failure probability is lower than the first threshold value.

9. The apparatus according to claim 7, wherein operation data of a plurality of electronic devices and information concerning one or more of the electronic devices having failures are obtained from the outside; a calculation formula of the failure probability on a electronic device is updated by using the operation data; and the failure state information calculator uses an updated calculation formula to calculate the failure probability.

10. The apparatus according to claim 8, wherein the diagnosis unit performs diagnosis by using data within a filtering period in the history of the failure state information;
operation data on a plurality of electronic devices is obtained from outside;
a plurality of combinations each of which is a combination of a value of the filtering period and a value of the first threshold value are generated;
a diagnosis rank is calculated based on the operation data with respect to each of the plurality of combinations and with respect to each of the electronic devices; and
a combination of values of the first threshold value and the filtering period is selected such that a numeric value depending on a proportion occupied by a certain diagnosis rank is maximized or minimized.

11. The apparatus according to claim 10, wherein from among Pareto-optimal solutions found based on sets of numeric values depending on proportions respectively occupied by two or more diagnosis ranks for the plurality of combinations, one solution is selected, and the combination of values of the first threshold value and the filtering period is selected based on the selected one solution.

12. The apparatus according to claim 7, wherein the failure state information calculator calculates the failure probability by making Logit transform of the plurality of explanatory variables.

13. The apparatus according to claim 1, further comprising:
a collection unit to periodically collect operation data from the electronic device; and
an input unit to store in the first storage the operation data collected by the collection unit.

14. The apparatus according to claim 1, further comprising an output unit to output a diagnosis result calculated by the diagnosis unit.

15. The apparatus according to claim 1, further comprising an output unit to output the overall span characteristic calculated by the failure state information calculator.

16. An operation data analysis method comprising:
reading out operation data on an electronic device from a first storage;
reading out a span characteristic concerning a time span in which each of values of a plurality of explanatory variables is changed from a second storage;
calculating the plurality of explanatory variables based on the operation data;
calculating failure state information for the electronic device based on the plurality of explanatory variables as calculated, and calculating, when the failure state information represents a risky state, an overall span characteristic concerning in what time span the failure state information is possibly to represent a safe state due to changes in the values of the explanatory variables; and
diagnosing the electronic device based on the failure state information and the overall span characteristic.

17. A non-transitory computer readable medium having instructions stored therein which, when executed by a processor, causes the processor to performs processing of steps comprising:
reading out operation data on an electronic device from a first storage;
reading out a span characteristic concerning a time span in which each of values of a plurality of explanatory variables is changed from a second storage;
calculating the plurality of explanatory variables based on the operation data;
calculating failure state information for the electronic device based on the plurality of explanatory variables as calculated, and calculating, when the failure state information represents a risky state, an overall span characteristic concerning in what time span the failure state information is possibly to represent a safe state due to changes in the values of the explanatory variables; and
diagnosing the electronic device based on the failure state information and the overall span characteristic.
